(19) United States
(12) Patent Application Publication
(10) Pub. No.: US 2016/0336702 A1
(43) Pub. Date: Nov. 17, 2016

(54) RETRACTABLE MULTIFUNCTIONAL CONNECTING DEVICE

(71) Applicant: SHENG-HSIN LIAO, NEW TAIPEI CITY (TW)

(72) Inventor: SHENG-HSIN LIAO, NEW TAIPEI CITY (TW)

(21) Appl. No.: 14/825,294

(22) Filed: Aug. 13, 2015

(30) Foreign Application Priority Data
May 13, 2015 (TW) 104115216

(51) Int. Cl. H01R 27/00

(52) U.S. Cl. CPC H01R 27/00

(57) ABSTRACT

A retractable multifunctional connecting device includes a first module, a second module, and an outer casing body. The first module includes a first insulating body and a first terminal group, the first terminal group is disposed at the first insulating body. The second module includes a second insulating body and a second terminal group, the second terminal group is disposed at the second insulating body. The outer casing body houses the first module having an external portion. The outer casing body has a front end formed with an opening, a surface of the outer casing body is formed with a cleaved hole, two flanges are respectively disposed at two sides of the cleaved hole on the outer casing, the second module is limited to a position by abutting against the two flanges, and the second module moves along the two flanges.

### BACKGROUND OF THE INVENTION

1. Field of the Invention

The instant disclosure relates to a connecting device; in particular, to a retractable multifunctional connecting device.

2. Description of Related Art

The Universal Serial Bus (USB) of prior art has been most widely used in interface bus specifications in today's communication products. Various communication products are usually assigned with one or a plurality of USB connectors. For realizing the small and thin requirement of portable communication products, a Mini USB connector and a Micro USB connector having smaller volumes have been successively released.

However, all of the recent USB connectors are designed with only one single specification, the application is limited, and it is inconvenient. For example, USB A type, USB B type, USB C type, Mini USB, or Micro USB. Otherwise, other types of connectors have the same problem.

In summary, the inventor of this instant disclosure has contributed to research and developed the connecting device of the instant disclosure to overcome the abovementioned drawbacks.

### SUMMARY OF THE INVENTION

This instant disclosure provides a retractable multifunctional connecting device to overcome the abovementioned drawback. The retractable multifunctional connecting device of the instant disclosure has various specifications for selection, a user can use the required specifications by retraction depending upon different requirements, and it can be widely used and is convenient.

In order to overcome the abovementioned problem, the instant disclosure provides a retractable multifunctional connecting device which includes a first module, a second module, and an outer casing body. The first module includes a first insulating body and a first terminal group, the first terminal group is disposed at the first insulating body, the first terminal group includes several first terminals and several second terminals, each of the first terminals is formed with a first contact portion and a first connecting portion, and each of the second terminals is formed with a second contact portion and a second connecting portion. The second module includes a second insulating body and a second terminal group, the second terminal group is disposed at the second insulating body, the second terminal group includes several third terminals and several fourth terminals, each of the third terminals is formed with a third contact portion and a first guide contact portion, and each of the fourth terminals is formed with a fourth contact portion and a second guide contact portion. The second module is forward and backward movably disposed on the first module, the second module is moved to a first position and a second position, and the first guide contact portions and the second guide contact portions are contacted with the corresponding first contact portions and the second contact portions when the second module is moved to the first position, so that the second terminal group is electrically connected to the first terminal group. The first guide contact portions and the second guide contact portions are separated from the first contact portions and the second contact portions when the second module is moved to the second position, so that the second terminal group is electrically separated from the first terminal group. The outer casing body houses the first module having an external portion, the outer casing body having a front end is formed with an opening, a surface of the outer casing body is formed with a cleaved hole, two flanges are respectively disposed at two sides of the cleaved hole on the outer casing body, the second module is limited to a position by abutting against the two flanges, and the second module moves along the two flanges.

In order to overcome the abovementioned problem, the instant disclosure further provides a retractable multifunctional connecting device which includes a first module, a second module, and an outer casing body. The first module includes a first insulating body and a first terminal group, the first terminal group is disposed at the first insulating body, the first terminal group includes several first terminals, and each of the first terminals is formed with a first contact portion and a first connecting portion. The second module includes a second insulating body and a second terminal group, the second terminal group is disposed at the second insulating body, the second terminal group includes several third terminals, and each of the third terminals is formed with a third contact portion and a first guide contact portion. The second module is forward and backward movably disposed on the first module, the second module is moved to a first position and a second position, and the first guide contact portions are contacted with the corresponding first contact portions when the second module is moved to the first position, so that the second terminal group is electrically connected to the first terminal group. The first guide contact portions are separated from the first contact portions when the second module is moved to the second position, so that the second terminal group is electrically separated from the first terminal group. The outer casing body houses the first module having an external portion, the outer casing body having a front end is formed with an opening, a surface of the outer casing body is formed with a cleaved hole, two flanges are respectively disposed at two sides of the cleaved hole on the outer casing body, the second module is limited to a position by abutting against the two flanges, and the second module moves along the two flanges.

In order to overcome the abovementioned problem, the instant disclosure further provides a retractable multifunctional connecting device which includes a first module, a third module, and an outer casing body. The first module includes a first insulating body and a first terminal group, the first terminal group is disposed at the first insulating body, the first terminal group includes several first terminals, and each of the first terminals is formed with a first contact portion and a first connecting portion. The third module is electrically connected to the first terminal group of the first module by a connecting line, and the third module is movably disposed on the first module. The outer casing body houses the first module having an external portion, the outer casing body having a front end is formed with an opening, a surface of the outer casing body is formed with a cleaved hole, two flanges are respectively disposed at two sides of the cleaved hole on the outer casing body, the third module is limited to a position by abutting against the two flanges, and the third module moves along the two flanges.

The instant disclosure has the following advantages:

1. The connecting device of the instant disclosure is designed to be retractable. The second module is forward and backward movably disposed on the first module to provide various specifications for selection, and the user can choose the first module or the second module, so that it can be widely used and is convenient.

2. The cleaved hole and flanges are disposed in the outer casing body of the instant disclosure, the second module can use the flanges for guiding to stably move forward and backward, and the second module also can use the flanges for holding and limiting the position to be stably disposed on the first module, such that the first module and the second module can be stably electrically connected with each other.

In order to further appreciate the characteristics and technical contents of the present invention, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows an exploded perspective view of a connecting device of a first embodiment in the instant disclosure;

FIG. 2 shows a combined perspective view of the connecting device of the first embodiment in the instant disclosure;

FIG. 3 shows an exploded perspective view of a second module of the first embodiment in the instant disclosure;

FIG. 4 shows a combined perspective view of the second module of the first embodiment in the instant disclosure;

FIG. 5 shows a schematic view of the connecting device in use state of the first embodiment in the instant disclosure;

FIG. 6 shows a schematic view of the connecting device in another use state of the first embodiment in the instant disclosure;

FIG. 7 shows an exploded perspective view of the connecting device of a second embodiment in the instant disclosure;

FIG. 8 shows a schematic view of the connecting device in use state of the second embodiment in the instant disclosure;

FIG. 9 shows a schematic view of the connecting device of a third embodiment in the instant disclosure;

FIG. 10 shows a schematic view of the connecting device of a fourth embodiment in the instant disclosure;

FIG. 11 shows a combined perspective view of the connecting device of a fifth embodiment in the instant disclosure;

FIG. 12 shows a schematic view of the connecting device of a sixth embodiment in the instant disclosure;

FIG. 13 shows a combined perspective view of the connecting device of a seventh embodiment in the instant disclosure; and

FIG. 14 shows an exploded perspective view of the connecting device of an eighth embodiment in the instant disclosure.

### DETAILED DESCRIPTION OF THE PREFERRED EMBODIMENTS

### First Embodiment

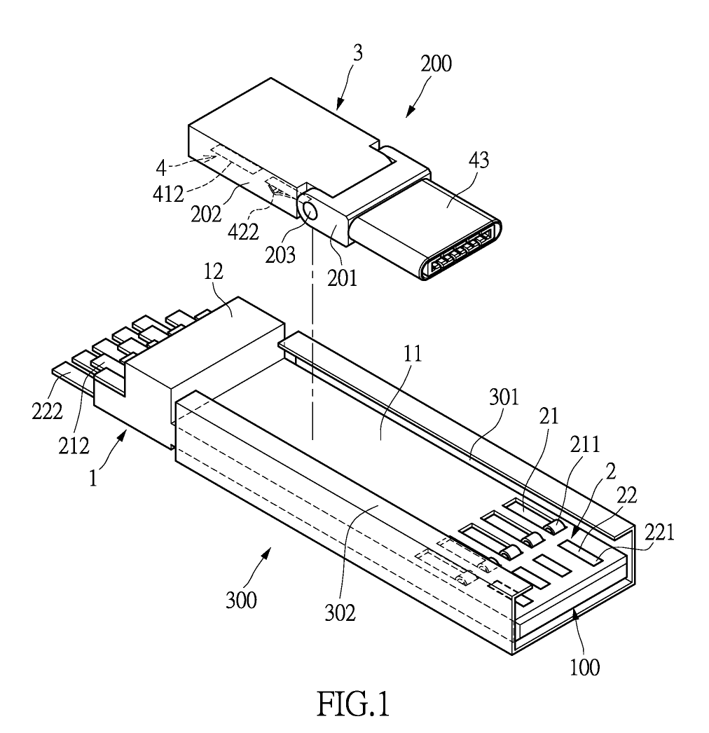

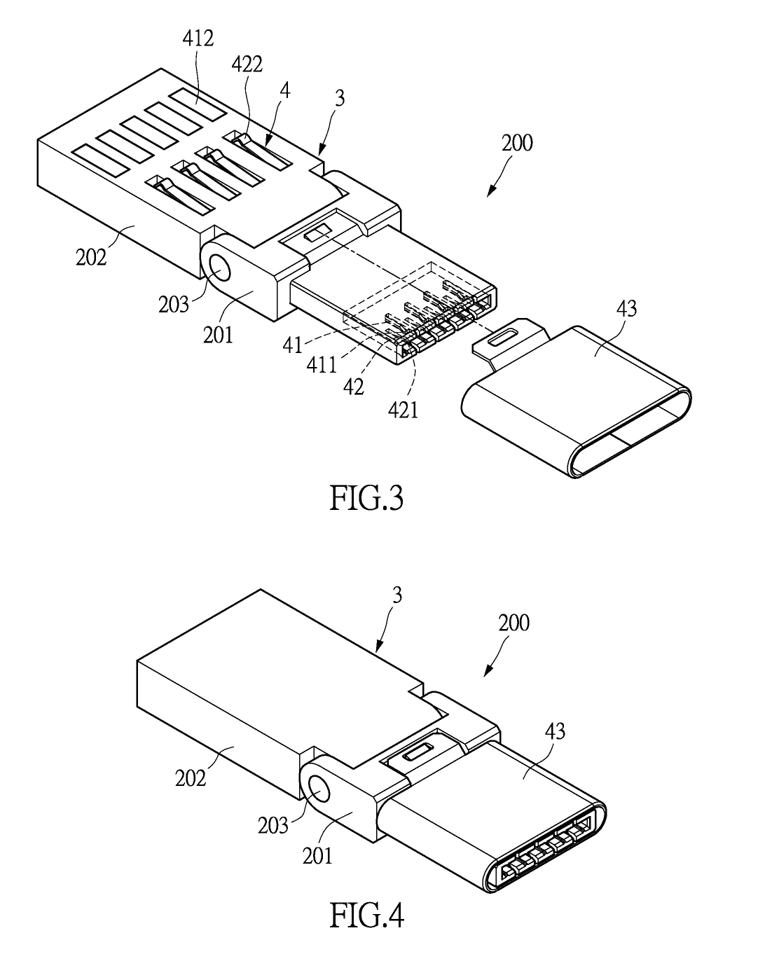

Please refer to FIGS. 1 to 4. The instant disclosure provides a retractable multifunctional connecting device which includes a first module 100, a second module 200, and an outer casing body 300. In the embodiment, the first module 100 is a specification of USB 3.0 A type, the second module 200 is a specification of USB 2.0 C type, but the specifications of the first and second modules 100, 200 are not limited. Examples of the specifications of the first and second modules 100, 200 include, but are not limited to A type, B type, C type, Micro USB, and Mini USB of USB 3.0 or 2.0. The first and second modules 100, 200 may be a plug and socket form.

The first module 100 includes a first insulating body 1 and a first terminal group 2, and the first terminal group 2 is disposed on the first insulating body 1 to cooperatively assemble to the first module 100. In the embodiment, the first terminal group 2 includes several first terminals 21 and several second terminals 22. The first terminals 21 are disposed on the first insulating body 1, and can carry out USB 2.0 transfer protocol. The second terminals 22 are disposed on the first insulating body 1, and can cooperate with the first terminals 21 to carry out USB 3.0 transfer protocol. The second terminals 22 may have two pairs of high frequency transmission terminals and a ground terminal between the two pairs of high frequency transmission terminals.

Each of the first terminals 21 and the second terminals 22 has a front end that is formed with a first contact portion 211 and a second contact portion 221 respectively. The first contact portions 211 and the second contact portions 221 may be exposed to a surface of the first insulating body 1, and are arranged in two lines to be used for contacting and electrically connecting to a docking connector having a terminal. Each of the first terminals 21 and the second terminals 22 has a rear end that is formed with a first connecting portion 212 and a second connecting portion 222 respectively. The first connecting portions 212 and the second connecting portions 222 are protruded from the first insulating body 1 to be used for welding and electrically connecting to a cable, a circuit board, or other devices, but it is not limited herein. Of course, the first connecting portions 212 and the second connecting portions 222 may also be designed for a contact portion structure, so as to facilitate the terminal of the docking connector contacting and electrically connecting to the contact portion structure.

The first insulating body 1 may have a receiving portion 11 and a stopping portion 12. The stopping portion 12 is connected to the receiving portion 11 having a rear end, and the stopping portion 12 is protruded from the receiving portion 11 having a top surface. The first contact portion 211 of the first terminal 21 and the second contact portion of the second terminal may be exposed to one surface of the receiving portion 11.

The second module 200 includes a second insulating body 3 and a second terminal group 4, and the second terminal group 4 is disposed at the second insulating body 3 to cooperatively assemble to the second module 200. The second insulating body 3 is substantially a flat plate, the second terminal group 4 includes several terminals 41, 42. In the embodiment, the second terminal group 4 includes several third terminals 41 and several fourth terminals 42, the third terminals 41 and the fourth terminals 42 are disposed at the second insulating body 3, and can cooperatively carry out USB C type transfer protocol.

Each of the third terminals 41 and the fourth terminals 42 has a front end that is formed with a third contact portion 411 and a fourth contact portion 421 respectively. The third contact portion 411 and the fourth contact portion 421 may be respectively exposed to the second insulating body 3 having internal upper and lower rows to be used for contacting and electrically connecting to the terminal of the docking connector. Each of the third terminals 41 and the fourth terminals 42 has a rear end that is formed with a first guide contact portion 412 and a second guide contact portion 422 respectively. The first guide contact portions 412 and the second guide contact portions 422 are protruded from the second insulating body 3 to be used for selectively contacting with the first contact portions 211 and the second contact portions 221, and the second terminal group 4 can be electrically connected to the first terminal group 2. A metal casing body 43 may be used to house outside of the second insulating body 3 and the second terminal group 4.

In the embodiment, the first terminal group 2 includes the several first terminals 21 and the several second terminals 22, the second terminal group 4 includes several third terminals 41 and several fourth terminals 42, but it is not limited herein. Numbers and types of the first terminal group 2 and the second terminal group 4 may be varied.

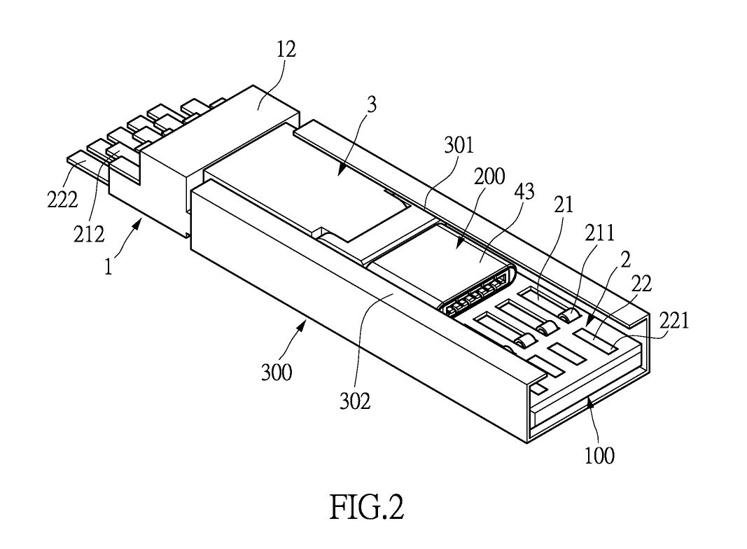

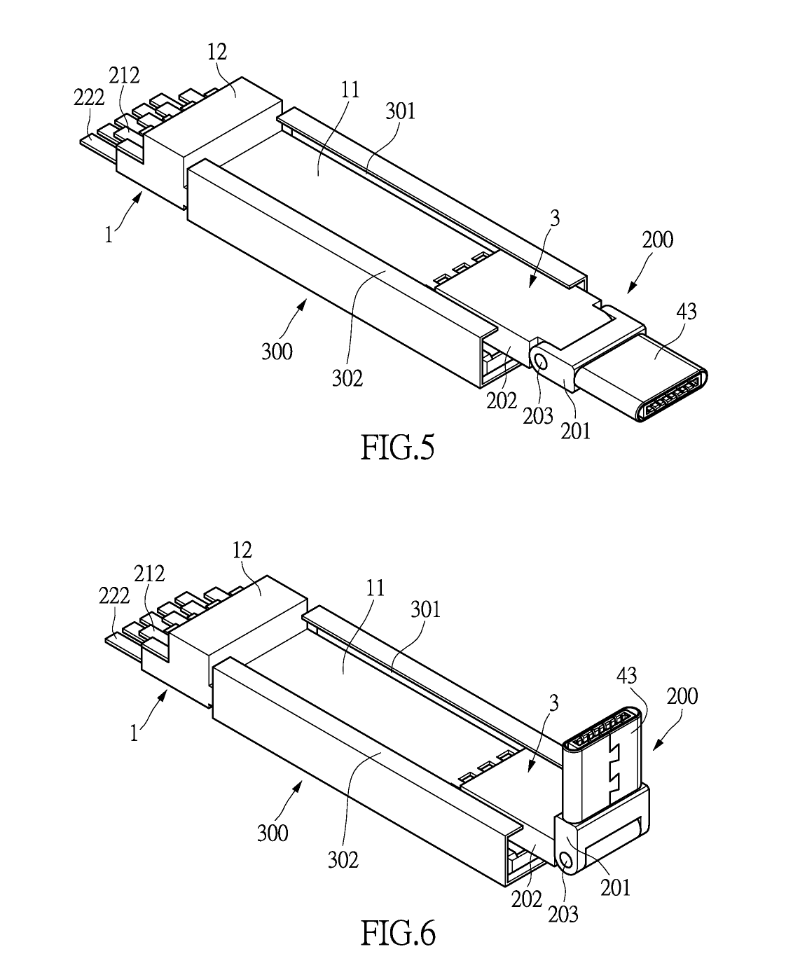

The second module 200 can be forward and backward movably disposed on the first module 100, that is, the second module 200 can be forward and backward movably disposed on the receiving portion 11 of the first insulating body 1. The second module 200 is moved to a first position and a second position, and the first guide contact portions 412 and the second guide contact portions 422 are contacted with the corresponding first contact portions 211 and the second contact portions 221 when the second module 200 is moved to the first position (as shown in FIG. 5), so that the second terminal group 4 is electrically connected to the first terminal group 2. That is, the second terminal group 4 and the first terminal group 2 are connected to a device such as the cable or the circuit board which is in a conducting state, and the second module 200 is in a usable state. The first guide contact portions 412 and the second guide contact portions 422 are separated from the first contact portions 211 and the second contact portions 221 when the second module 200 is moved to the second position (as shown in FIG. 2), so that the second terminal group 4 is electrically separated from the first terminal group 2. That is, the second terminal group 4 and the first terminal group 2 are connected to the device such as the cable or the circuit board which is in a non-conducting state, and the second module 200 is in an unusable state. At the same time, a front section of the first module 100 is exposed, that is, a front section of the first insulating body 1, the first contact portion 211 of the first terminals 21, and the second contact portion 221 of the second terminals 22 are exposed, so that the first module 100 is in the usable state. Accordingly, the connecting device is retractable via the second module 200 moved forward and backward, and the first module 100 and the second module 200 can be freely switched to be used respectively.

In addition, in another embodiment of the instant disclosure, the first terminal group 2 may also only include several first terminals 21, the second terminal group 4 may also only include several third terminals 41, and the second module 200 is forward and backward movably disposed on the first module 100. The first guide contact portions 412 are contacted with the corresponding first contact portions 211 when the second module 200 is moved to the first position, and the second terminal group 4 is electrically connected to the first terminal group 2. The first guide contact portions 412 are separated from the first contact portions 211 when the second module 200 is moved to the second position, and the second terminal group 4 is electrically separated from the first terminal group 2.

A front section of the second module 200 may be further designed to be reversible, that is, the second module 200 is divided into a front section 201 and a rear section 202, and the front section 201 and the rear section 202 are hinged together using a pivot mechanism 203, so as to facilitate the second module 200 which can be further flipped upward (as shown in FIG. 6) when the second module 200 is moved forward to the first position, and it is easy to use. The third terminals 41 and the fourth terminals 42 disposed on the abovementioned front section 201 and rear section 202 are also correspondingly divided into two parts (not shown), and a wire line, a guide sheet, or a flexible circuit board is used to connect between the two parts.

The second module 200 is forward and backward movably disposed on the first module 100, when the second module 200 is moved backward to the second position, the second module 200 having a rear end can abut against the stopping portion 12 of the first insulating body 1 to locate the position (as shown in FIG. 2), but a positioning structure is not limited herein. When the second module 200 is moved forward to the first position or backward to the second position, a proper positioning structure (not shown) may be disposed to locate the position. Any structure having stopping and positioning function such as a block or a hook may be disposed to locate the position.

The outer casing body 300 houses the first module 100 having an external portion, that is, the outer casing body 300 can house the first insulating body 1 having an external portion, and the outer casing body 300 may be made of a metal material. The outer casing body 300 having a front end is formed with an opening, a surface (top surface) of the outer casing body 300 is formed with a cleaved hole 301, and the cleaved hole 301 extends to the front and rear ends of the outer casing body 300. Two flanges 302 are respectively disposed at two sides of the cleaved hole 301 on the outer casing body 300, two upper ends of the two sides of the outer casing body 300 extend inward to form the two flanges 302, and the two flanges 302 are horizontally disposed and are in parallel with each other. The second module 200 also may be housed by the outer casing body 300, a width of the second module 200 is larger than a width of the cleaved hole 301, so that the second module 200 can be limited to a position by abutting against the two flanges 302, and the second module 200 can move between the first and second positions along the two flanges 302. The front section 201 of the second module 200 having a width that is slightly bigger than the width of the cleaved hole 301, such that the user can just apply a little force, and the front section 201 of the second module 200 can be flipped downward to abut against the two flanges 302 to limit the position, or be flipped upward to separate the two flanges 302.

### Second Embodiment

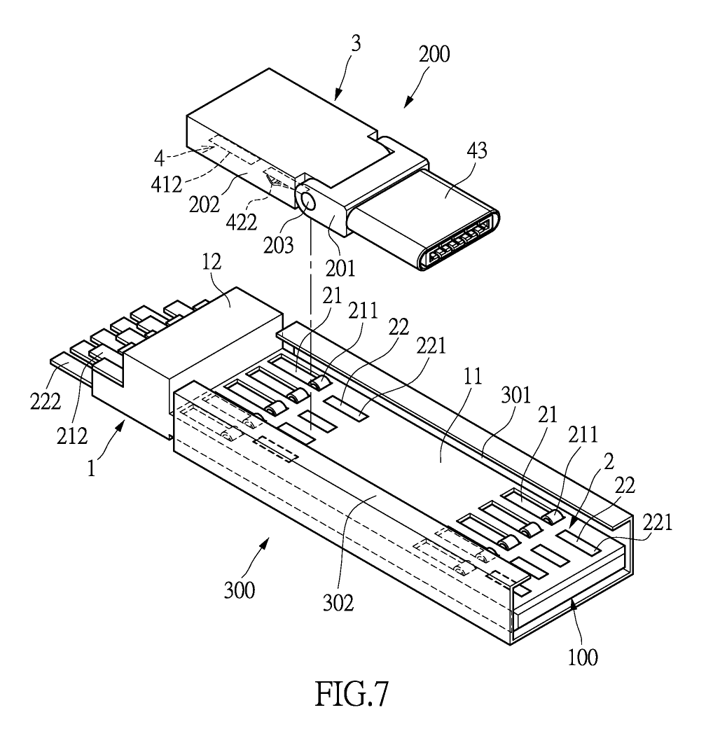

Please refer to FIG. 7. In the embodiment, each of the front ends of the first terminals 21 is respectively formed with two first contact portions 211 located at different front and back positions. In the embodiment, two first positions being disposed therein, when the second module 200 is moved to each of the first positions, the second terminal group 4 can be electrically connected to both the front and back positions of the first terminal group 2. That is, when the second module 200 is selectively moved to each of the first positions, the first guide contact portions 412 and the second guide contact portions 422 are contacted with the corresponding first contact portions 211 and the second contact portions 221, so that the second terminal group 4 is electrically connected to the first terminal group 2.

Of course, each of the front ends of the first terminals 21 may be formed with several first contact portions 211 located at the different front and back positions (not shown), and each of the front ends of the second terminals 22 may be formed with several second contact portions 221 located at the different front and back positions (not shown). When the second module 200 is selectively moved to a plurality of first positions, the first guide contact portions 412 and the second guide contact portions 422 are contacted with the corresponding first contact portions 211 and the second contact portions 221, so that the second terminal group 4 is electrically connected to the first terminal group 2. In the embodiment, a plurality of first positions are disposed therein, when the second module 200 is moved to each of the first positions, the second terminal group 4 can be electrically connected to the different front and back positions of the first terminal group 2.

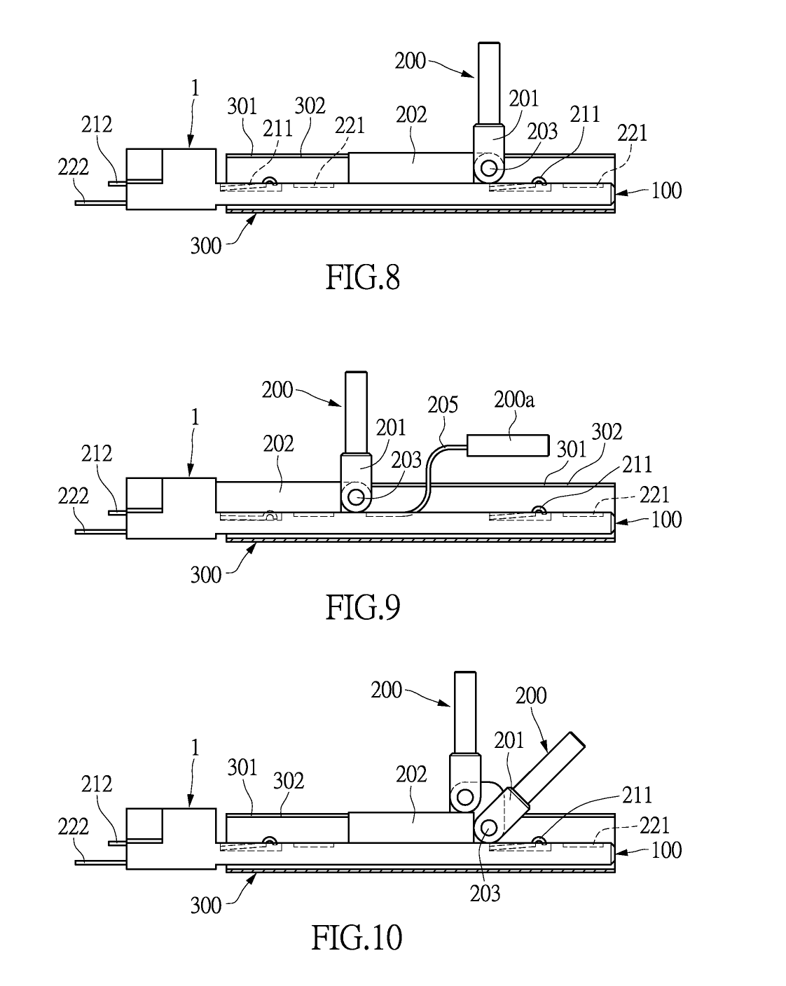

Please refer to FIG. 8. In the embodiment, when the second module 200 is moved to each of the first positions, the second terminal group 4 can be electrically connected to both of the first positions of the first terminal group 2, and the front section 201 of the second module 200 can be flipped upward to be easily used.

### Third Embodiment

Please refer to FIG. 9. In the embodiment, a third module 200a is further disposed therein, the third module 200a is electrically connected to the first terminal group 2 of the first module 100 by a connecting line 205, the connecting line 205 has a flexibility, and the third module 200a can be movably disposed on the first module 100. The third module 200a also can be limited to a position by the two flanges abutting against the outer casing body 300, the third module 200a can be forward and backward movably disposed at the first module 100, and the third module 200a also can be flipped upward to be easily used.

### Fourth Embodiment

Please refer to FIG. 10. In the embodiment, two second modules 200 are disposed therein, the two second modules 200 can be forward and backward movably disposed on the first module 100 and can be electrically connected to the first module 100, when the two second modules 200 are moved to the first position. The two second modules 200 also can respectively be flipped upward with a proper angle to be easily used.

### Fifth Embodiment

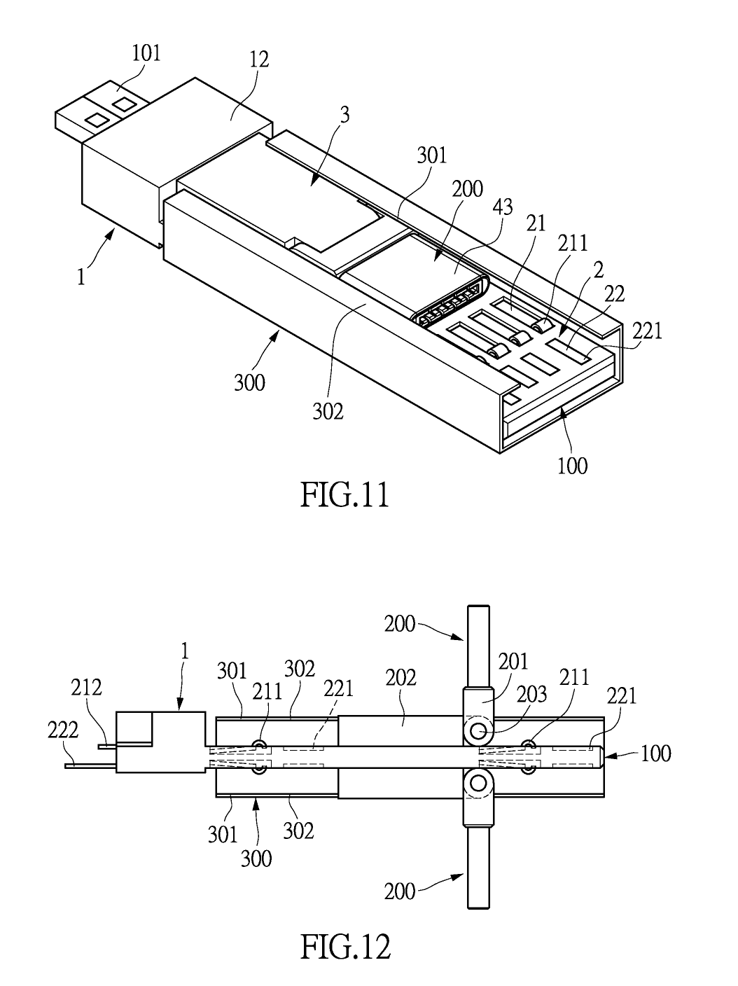

Please refer to FIG. 11. In the embodiment, the first insulating body 1 of the first module 100 and the rear end of the first terminal group 2 are varied, and the first connecting portion 212 of the first terminals 21 and the second connecting portion 222 of the second terminals 22 are designed for a contact portion structure, so that the rear end of the first module 100 is formed into an adapter 101 to facilitate electrically connecting to the docking connector.

### Sixth Embodiment

Please refer to FIG. 12. In the embodiment, the first contact portions 211 and the second contact portions 221 are exposed to two surfaces of the first insulating body 1, each of the front ends of the first terminals 21 is formed with two first contact portions 211 located at the different front and back positions, and each of the front ends of the second terminals 22 is formed with two second contact portions 221 located at the different front and back positions. Two second modules 200 are forward and backward movably disposed at the first module 100 having a top portion and a bottom portion respectively, the two second modules 200 can be moved to the first and second positions, and the second terminal group 4 can be electrically connected and separated to the first terminal group 2. The outer casing body 300 houses the external portion of the first module 100, both two surfaces of the outer casing body 300 are respectively formed with the cleaved holes 301, the two flanges 302 are respectively disposed at two sides of the two cleaved holes on the outer casing body 300, so that the two second modules 200 are limited their position by abutting against the flanges 302, and the two second modules 200 move along the flanges 302.

### Seventh Embodiment

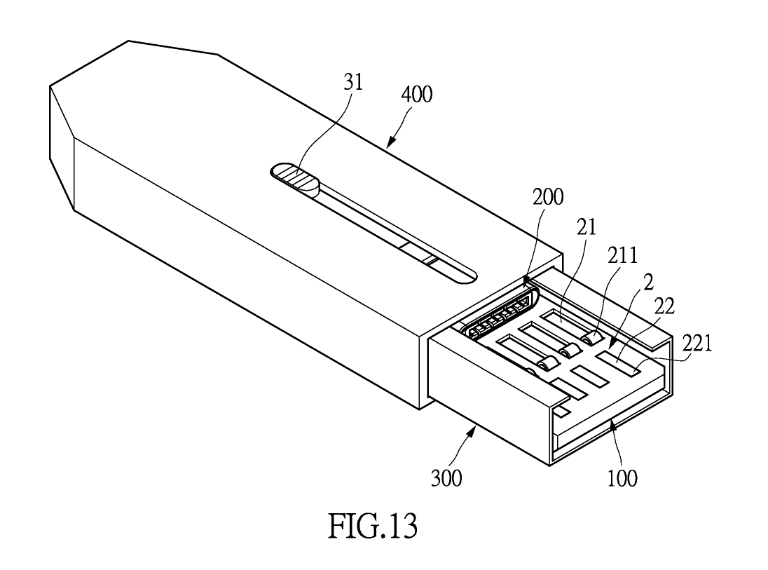

Please refer to FIG. 13. In the embodiment, a housing body 400 is further disposed at the rear end of the first module 100 and the outer casing body 300, using an injection molding or assembling way, and a memory is electrically connected to the first module 100 and the second module 200, so as to assemble a storage device. A pushing button 31 also may be protrudingly disposed on the second module 200, and the pushing button 31 can be protrudingly disposed at the top surface or the one side of the second insulating body 3. In the embodiment, the pushing button 31 is protrudingly disposed at the top surface of the second insulating body 3, and the pushing button 31 is passed through the housing body 400 to facilitate forward and backward pushing of the second module 200.

### Eight Embodiment

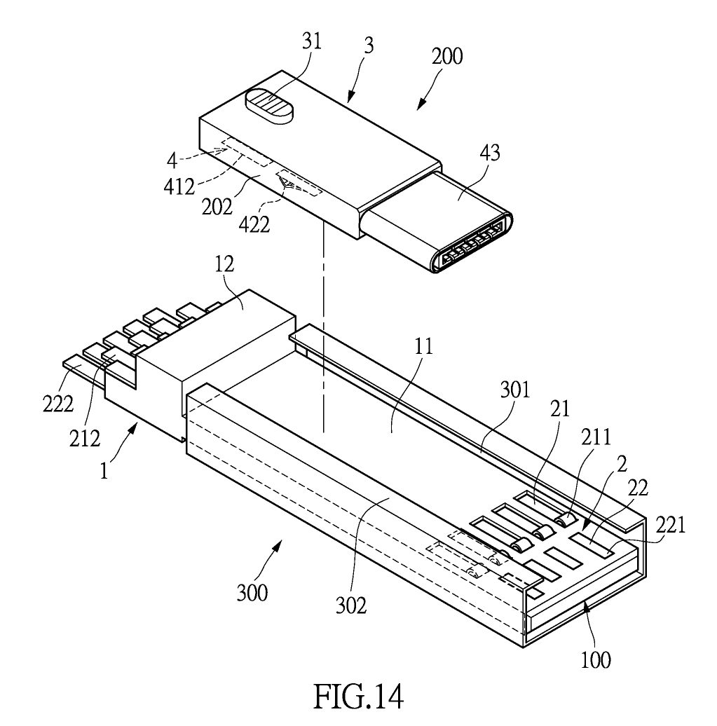

Please refer to FIG. 14. In the embodiment, the second module 200 is a fixed type, that is, the second module 200 cannot be flipped upward. The pushing button 31 is also protrudingly disposed on the second module 200, the pushing button 31 can be protrudingly disposed on the top surface or one side of the second insulating body 3, so as to facilitate forward and backward pushing the second module 200.

The connecting device of the instant disclosure is designed to be retractable. The second module can be forward and backward movably disposed on the first module to provide various specifications for selection, and the user can choose the first module or the second module, so that it can be widely used and is convenient.

The cleaved hole and flanges are disposed in the outer casing body of the instant disclosure, the second module can use the flanges for guiding to stably move forward and backward, and the second module also can use the flanges for holding and limiting the position to be stably disposed on the first module, such that the first module and the second module can be stably electrically connected with each other.

The second module of the instant disclosure also may be designed to be flappable, such that it can be widely used and is more convenient, and it may have extending and adapting functions.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. A retractable multifunctional connecting device, comprising:
a first module including a first insulating body and a first terminal group, the first terminal group disposed at the first insulating body, the first terminal group including several first terminals and several second terminals, each of the first terminals formed with a first contact portion and a first connecting portion, and each of the second terminals formed with a second contact portion and a second connecting portion;
a second module including a second insulating body and a second terminal group, the second terminal group disposed at the second insulating body, the second terminal group including several third terminals and several fourth terminals, each of the third terminals formed with a third contact portion and a first guide contact portion, and each of the fourth terminals formed with a fourth contact portion and a second guide contact portion;
the second module forward and backward movably disposed on the first module, the second module moved to a first position and a second position, and the first guide contact portions and the second guide contact portions contacted with the corresponding first contact portions and the second contact portions when the second module is moved to the first position, so that the second terminal group is electrically connected to the first terminal group; the first guide contact portions and the second guide contact portions are separated from the first contact portions and the second contact portions when the second module is moved to the second position, so that the second terminal group is electrically separated from the first terminal group; and
an outer casing body housing the first module having an external portion, the outer casing body having a front end formed with an opening, a surface of the outer casing body formed with a cleaved hole, two flanges being respectively disposed at two sides of the broken hole on the outer casing body, the second module being limited to a position by abutting against the two flanges, and the second module moving along the two flanges.

2. The retractable multifunctional connecting device claimed in claim 1, wherein two upper ends of the two sides of the outer casing body extend inward to form the two flanges, and the two flanges are horizontally disposed and are in parallel with each other.

3. The retractable multifunctional connecting device claimed in claim 1, wherein the second module is divided into a front section and a rear section, and the front section and the rear section are hinged together using a pivot mechanism.

4. The retractable multifunctional connecting device claimed in claim 1, wherein two or several first contact portions are disposed at the first terminal, and two or several second contact portions are disposed at the second terminal.

5. The retractable multifunctional connecting device claimed in claim 1, wherein the first connecting portion of the first terminals and the second connecting portion of the second terminals are formed into a contact portion structure, so that the first module having a rear end is formed into an adapter.

6. The retractable multifunctional connecting device claimed in claim 1, further comprising a third module, the third module electrically connected to the first terminal group of the first module by a connecting line, and the third module being movably disposed on the first module.

7. The retractable multifunctional connecting device claimed in claim 6, wherein the third module is limited to a position by abutting against the two flanges, and the third module moves along the two flanges.

8. The retractable multifunctional connecting device claimed in claim 1, wherein the first contact portions and the second contact portions are exposed to two surfaces of the first insulating body, two second modules are forward and backward movably disposed at the first module having a top portion and a bottom portion respectively, both two surfaces of the outer casing body are formed with the cleaved holes, the flanges are disposed at both two sides of the two cleaved holes, so that the two second modules are limited to their position by abutting against the flanges, and the two second modules move along the flanges.

9. A retractable multifunctional connecting device, comprising:
a first module including a first insulating body and a first terminal group, the first terminal group disposed at the first insulating body, the first terminal group including several first terminals, and each of the first terminals formed with a first contact portion and a first connecting portion;
a second module including a second insulating body and a second terminal group, the second terminal group disposed at the second insulating body, the second terminal group including several third terminals, and each of the third terminals formed with a third contact portion and a first guide contact portion;
the second module forward and backward movably disposed on the first module, the second module moved to a first position and a second position, and the first guide contact portions contacted with the corresponding first contact portions when the second module is moved to the first position, so that the second terminal group is electrically connected to the first terminal group; the first guide contact portions separated from the first contact portions when the second module is moved to the second position, so that the second terminal group is electrically separated from the first terminal group; and
an outer casing body housing the first module having an external portion, the outer casing body having a front end formed with an opening, a surface of the outer casing body formed with a cleaved hole, two flanges being respectively disposed at two sides of the cleaved hole on the outer casing body, the second module being limited to a position by abutting against the two flanges, and the second module moving along the two flanges.

10. The retractable multifunctional connecting device claimed in claim 9, wherein the second module is divided into a front section and a rear section, and the front section and the rear section are hinged together using a pivot mechanism.

11. The retractable multifunctional connecting device claimed in claim 9, wherein two upper ends of the two sides of the outer casing body extend inward to form the two flanges, and the two flanges are horizontally disposed and are in parallel with each other.

12. The retractable multifunctional connecting device claimed in claim 9, wherein two or several first contact portions are disposed at the first terminal.

13. The retractable multifunctional connecting device claimed in claim 9, wherein the first connecting portion of the first terminals is formed into a contact portion structure, so that the first module having a rear end is formed into an adapter.

14. The retractable multifunctional connecting device claimed in claim 9, further comprising a third module, the third module electrically connected to the first terminal group of the first module by a connecting line, and the third module being movably disposed on the first module.

15. The retractable multifunctional connecting device claimed in claim 14, wherein the third module is limited to a position by abutting against the two flanges, and the third module moves along the two flanges.

16. A retractable multifunctional connecting device, comprising:
a first module including a first insulating body and a first terminal group, the first terminal group disposed at the first insulating body, the first terminal group including several first terminals, and each of the first terminals formed with a first contact portion and a first connecting portion;
a third module, the third module electrically connected to the first terminal group of the first module by a connecting line, and the third module being movably disposed on the first module; and
an outer casing body housing the first module having an external portion, the outer casing body having a front end formed with an opening, a surface of the outer casing body formed with a cleaved hole, two flanges being respectively disposed at two sides of the cleaved hole on the outer casing body, the third module being limited to a position by abutting against the two flanges, and the third module moving along the two flanges.

17. The retractable multifunctional connecting device claimed in claim 16, wherein two upper ends of the two sides of the outer casing body extend inward to form the two flanges, and the two flanges are horizontally disposed and are in parallel with each other.

18. The retractable multifunctional connecting device claimed in claim 16, wherein the first connecting portion of the first terminals is formed into a contact portion structure, so that the first module having a rear end is formed into an adapter.
